(19) United States
(12) Patent Application Publication
(10) Pub. No.: US 2005/0160064 A1
(43) Pub. Date: Jul. 21, 2005

(54) Confirming user rights in distribution of application programs

(76) Inventors: Arto Lehtonen, Kangasala (FI); Antti Savolainen, Tampere (FI); Tero Tykka, Tampere (FI); Tapani Saarinen, Tampere (FI); Jarno Kanto, Tampere (FI)

Correspondence Address: BURNS DOANE SWECKER & MATHIS L L P, POST OFFICE BOX 1404, ALEXANDRIA, VA, 22313-1404, US

(21) Appl. No.: 10/953,785

(22) Filed: Sep. 30, 2004

Related U.S. Application Data
(63) Continuation of application No. PCT/FI04/00042, filed on Jan. 29, 2004.

(30) Foreign Application Priority Data
Jan. 30, 2003 (FI) 20030138

(51) Int. Cl. G06F 7/00

(52) U.S. Cl. 707/1

(57) ABSTRACT

A method of confirming the user rights of a file to be loaded into a terminal, wherein a user of the terminal is requested to acknowledge a licence of the file. A single payment limit value is stored in the terminal for effecting a licence charge. After acknowledgement of the licence of the file, the price and identifier of the file, and the identifiers of the different parties to the distribution path are stored file-specifically. The prices of all loaded files are summed up and if the summed-up price exceeds the single payment limit value, a message authorizing a charge amounting to the single payment is transmitted to a third party responsible for the charge, the message comprising information on the identifiers of the files charged in the single payment, the identifiers of the different parties to the distribution path, and the portion of each file in the single payment.

### CROSS-REFERENCE TO RELATED APPLICATION

This application is a Continuation of International Application PCT/FI2004/000042 filed Jan. 29, 2004 which designated the U.S. and was published under PCT Article 21(2) in English.

### FIELD OF THE INVENTION

The invention relates to distributing application programs and particularly to confirming the user rights of a file loadable into a terminal.

### BACKGROUND OF THE INVENTION

An ever-increasing part of software development is associated with application programs developed onto various generally known and widely used platforms. A platform typically comprises basic hardware entities belonging to a given hardware environment, and basic software acting as the operating system. In case of an open platform, the configuration data on the hardware and the operating system software and on the essential interfaces are accessible to anyone, allowing also third parties to develop the application programs. Various open platforms are widely used both in computers and in devices closely related thereto, such as in mobile stations. Open platforms include for instance Java™, which is a purely software-based platform for use in both computers and mobile stations, and Symbian, which is designed for use particularly in a mobile communication environment.

Open platforms are operating environments advantageous to a software developer acting as a third party, since the devices using them are typically widely spread and generally used, i.e. the number of potential application program clients is also large. Typically, a software developer is able to offer his products for sale either directly or via a distribution company. An application program purchased by a client is loaded and installed into the client's terminal, wherein the program code comprised by the application program is run on the platform.

Irrespective of whether an application program is developed for an open or a closed environment, a major problem from the point of view of the software developer is to stop illicit duplication of application programs. Typically, the copyright and encryption methods preventing the duplication and decoding o f program files a re decryptable with a reasonable workload, after which an application program can be duplicated in principle into numerous terminals without the software developer receiving compensation for the duplicates The development of new protection methods, in turn, is extremely laborious and difficult.

### BRIEF DESCRIPTION OF THE INVENTION

The object of the invention is thus to provide a method and an apparatus for implementing the method so as to avoid the above-mentioned problems. The object of the invention is achieved with a method, software product and terminal, which are characterized in what is stated in the independent claims.

Preferred embodiments of the invention are described in the dependent claims.

The invention is based on creating a licence management functionality in a terminal using application programs or other files for confirming the user rights of a file loadable into the terminal. At least one file is loaded into the terminal, the starting of the file also starting the licence management functionality according to the invention, whereby the user of the terminal is requested to acknowledge the licence defined for the file. In accordance with the invention, a predetermined limit value for a single payment is arranged to be stored in the terminal for paying a licence fee, whereby an acknowledgement of the licence of the file is received from the user of the terminal. In response to the user's acknowledgement, at least the price of the file, the identifier of the file and the identifier of at least one party to the distribution path of the file are stored file-specifically, and simultaneously the prices of all files, loaded up to the present moment and not yet billed, are summed up. If the summed-up price of all loaded files exceeds or is equal to said predetermined limit value for the single payment, a message authorizing a charge amounting to the amount of the single payment is transmitted to a third party responsible for the charge, the message comprising information on the identifiers of the files to be charged for in said single payment, the identifiers of at least one party to the distribution path of the files, and the portion of each file in said single payment.

In accordance with a preferred embodiment of the invention, the user of the terminal is initially offered a temporary, e.g. 30-day, licence for using the file loaded for acknowledgement. If the user accepts the temporary licence, a timer defining the validity period of the temporary licence is initiated, and when the timer expires, the user is offered a new temporary licence for acknowledgement.

Furthermore, in accordance with a preferred embodiment of the invention, the invention is preferably applicable particularly in a mobile communication environment, wherein said terminal is a terminal of a mobile network and said third party responsible for the charge is a mobile operator, said message authorizing the charge amounting to the single payment being transmitted as a payment short message.

The licence management application of the invention enables an application program distribution chain, which brings forth a plurality of advantages particularly for an application developer as compared with the distribution methods of previously known programs. The application developer does not have to pay much attention to the copy protection of the application programs, since the use of the application programs in a terminal is subject to an acknowledgement of the licence performed by the user in the licence management application, which, in turn, results in an automatic licence fee from the user. A further advantage is that the mere loading of application programs into a terminal does not initiate payment instances, whereby the distribution of application programs for instance via free Internet pages or from one terminal to another is easy, and charging via the Internet, which users experience as unreliable, is simultaneously avoided. Also, the duplication of application programs from one terminal to another is no longer a threat to the application developer; instead, it offers additional alternatives for distributing the product. Another advantage is that licence fees can be easily paid in smaller instalments, e.g. monthly, allowing the user to pay for the use of an application only for the time he experiences as useful and to stop paying the licence fees in case he no longer wishes to use said program.

### BRIEF DESCRIPTION OF THE FIGURES

In the following, preferred embodiments of the invention will be described in detail with reference to the accompanying drawings, in which

FIG. 1 is a block diagram of the structure of an application program distribution chain, the use of which is enabled by means of the licence management application according to the invention;

FIG. 2 is a flow diagram of some preferred embodiments of the licence management functionality of the invention;

FIG. 3 shows, by way of example, the accumulation of licence fees in the licence management functionality and the payment of the fees as specified single payments; and

FIG. 4 shows the structure of a mobile station according to a preferred embodiment.

### DETAILED DESCRIPTION OF THE INVENTION

In the following, the invention will be described by way of example by means of a preferred embodiment, wherein the application programs are arranged to operate particularly in a mobile communication environment, a network operator being utilized as part of the distribution chain. It is evident to a person skilled in the art that the embodiments to be presented hereinafter are analogically applicable to any telecommunication network arrangement comprising the corresponding means for distributing application programs to clients and a so-called trusted third party for collecting the licence fees of the programs.

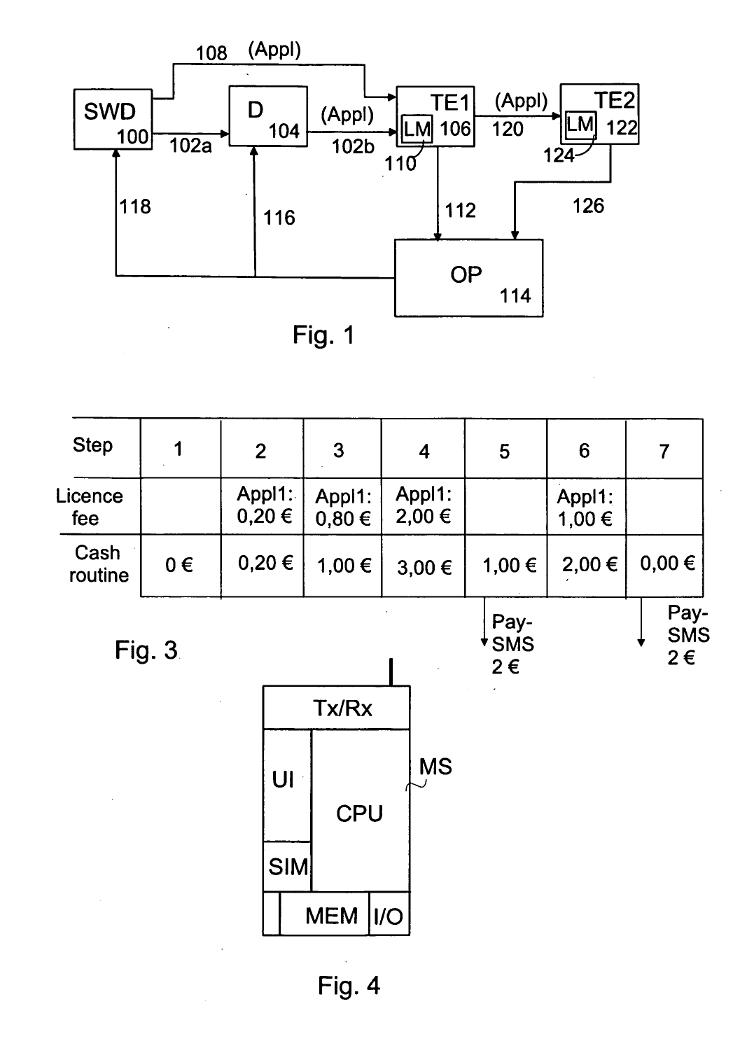

FIG. 1 is a block diagram of the structure of an application program distribution chain, the use of which is enabled by means of the licence management application according to the invention. In the distribution chain, a software developer SWD (100) develops an application program (Appl) for use in terminals of a mobile network, and the program goes on sale. The application program may be distributed to clients by first transferring (102a) the application program to a distributor D (104), which forwards (102b) the application program to an end user for installation in a terminal TE1 (106). The software developer SWD may also naturally forward (108) the application program directly to the client, whereby no distributor D is required in the distribution chain. The client can load the application program for instance over an Internet connection from an Internet page maintained by the software developer.

The application program to be delivered preferably comprises a program identifier (Appl_ID) and the price of the application program. The terminal TE1 now comprises the licence management functionality (LM) (110) according to the invention, the functionality being arranged to confirm the user rights of the application program, i.e. a licence, in response to an attempt to start the application program in the terminal for the first time. The licence management functionality requests the user of the terminal to input the licence code of the application program. If the client has the licence code he received when paying for the application program for instance in a store or via the Internet in his possession, the licence management functionality accepts the input licence code and the application program can be taken into use. If the client has no licence code, the licence management functionality allots either a full or a temporary licence for the use of the application program. The operation of the licence management functionality (LM) will be described in detail below in association with the checking of the licence code.

At the same time as the user of the terminal, who originally did not have a licence code obtained in association with the purchase, accepts the full or temporary licence suggested by the licence management functionality, the user also accepts the fee of the application program. The licence management functionality is arranged to collect licence fees into a buffer memory in such a manner that when the total sum of the accumulated licence fees reaches a predetermined limit value, a so-called trusted third party that collects the fees is sent a message (112) authorizing said third party to charge the user for a sum amounting to said limit value, the message comprising information on the applications (Appl_ID) taken into use, an optional distributor identifier (Distr_ID), and the portion of the charge of each application program of said sum equalling the limit value. In association with application programs used in a terminal of a mobile network, a mobile operator OP (114) can preferably act as the trusted third party that collects licence fees. In this case, the licence fees can be preferably delivered from the licence management functionality comprised by the terminal to the mobile operator as a payment short message (pay-SMS).

The trusted third party collecting licence fees, such as a mobile operator OP, in turn, distributes the income constituted by the licence fees among the application developer SWD, the operator OP and an optional distributor D in a proportion agreed upon in advance. Accordingly, the operator transfers a portion (116) to the distributor D and a portion (118) to the application developer SWD of the income constituted by the licence fees.

As the structure of the distribution chain according to FIG. 1 shows, the licence management functionality of the invention enables also the distribution of application programs from one terminal to another. Accordingly, the terminal TE1, comprising the licence management functionality, is able to deliver (120) an application program (Appl) to a second terminal TE2 (122) comprising the licence management functionality (124) via a data transfer mode supported by the terminals. In this case, a temporary licence is typically specified for the second terminal TE2 at the licence management functionality, an acceptance to the licence by the user initiating the above-described licence fee instance. Herein, when a payment short message (126) authorizing the operator to charge the user for the sum defined by said payment short message is transmitted from the licence management functionality of the terminal TE2 to the operator collecting the charges, the message includes not only information on the applications (Appl_ID) taken into use, but also the identifier (Distr_ID) of any previous distributor and the charge portion of each application program in the payment short message, and the identifier of the terminal TE1 having delivered the application. This enables the distribution of a portion of the licence fees also to the user of the terminal TE1, the portion being credited for instance as discounts in telephone bills from the operator OP.

Such an application program distribution chain, whose use is enabled by means of the licence management application according to the invention, brings forth a plurality of advantages compared with the distribution methods of previously known programs. The application developer does not have to pay much attention to the copy protection of the application programs, since the use of the application programs in the terminal is subject to a licence acknowledgement by the user in the licence management application, which, in turn, results in the user being automatically charged for the licence. A further advantage is that merely loading application programs into a terminal does not initiate payment instances, whereby the distribution of application programs for instance via free Internet pages or from one terminal to another is easy, and charging via the Internet, which users experience as unreliable, is simultaneously avoided. A still further advantage is that licence fees can easily be paid in smaller instalments, for instance monthly, allowing the user to pay for the use of an application only for the time he experiences as useful and to stop paying the licence fees in case he no longer wishes to use said program.

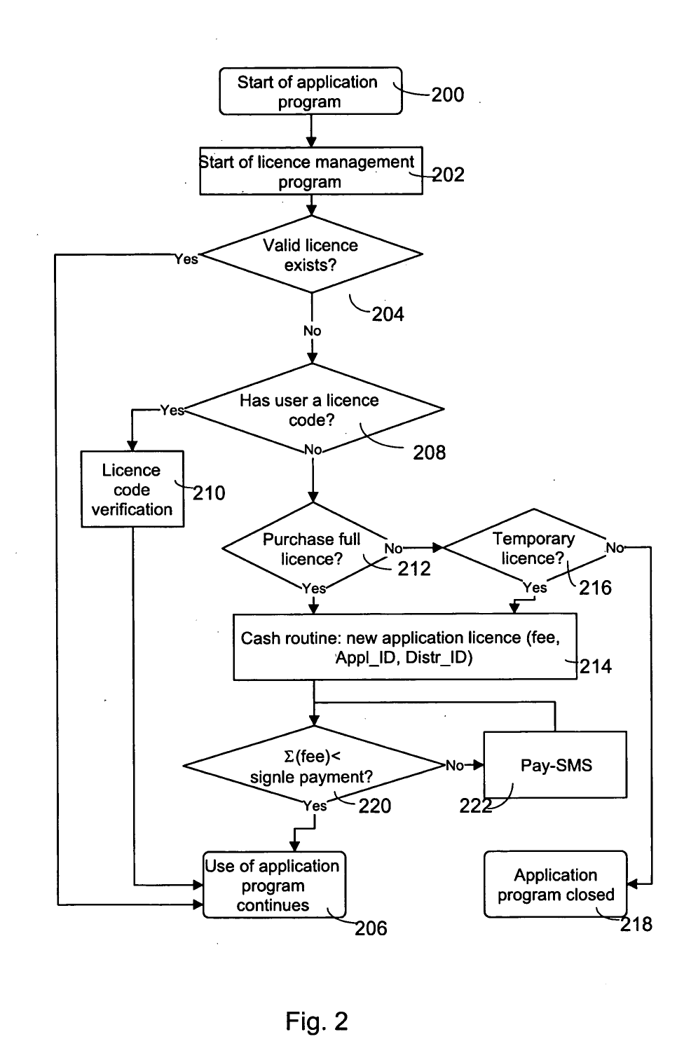

In the following, reference is made to the flow diagram of FIG. 2, by means of which some preferred embodiments of the licence management functionality of the invention are described. The licence management functionality is most preferably implemented as a dedicated application program, which can be loaded into a user's terminal TE, such as a mobile station MS. Accordingly, in the example of FIG. 2, the term licence management program can be used.

Starting (200) the application program (Appl) loaded into the terminal also starts the licence management program (202). The licence management program is preferably a program that is executed in the terminal as background processing and monitors the user rights of other application programs. At first, the licence management program checks if an application program initiated has a valid licence (204). In this case, the valid licence is registered either during a previous session or for instance in association with the purchase of the application program. If the application program has a valid licence, the use of the application program can be continued as usual (206).

If no valid licence exists, the licence management program requests that the user of the terminal input the licence code of the loaded application program (208). Such a situation may arise for instance when the loaded application program is taken into use for the first time and the licence code was delivered to the user of the terminal separate from the application program, the licence code serving as evidence that the specified payments were paid for the program. The licence code is preferably input using an input window opened on the display of the terminal, the user inputting the licence code in the window by means of the user interface of the terminal. The licence management program compares the input licence code with the identifier data comprised by the application program (210), and if the user input the correct licence code, the licence is registered as valid and the use of the application program can be continued as usual (206). The licence code may be checked for instance in checks sums calculated based on the identifier data comprised by the application program and compared with the input licence code. The licence code may also be checked (step 120) by the licence management program transmitting the input licence code by means of the terminal to a licence management server in a telecommunication network, the server comprising information on application programs gone on sale and their identifier data, and thus being capable of checking if the licence code is correct and acknowledging the check result to the licence management program comprised by the terminal.

If the licence code of the application program is not known to the user, which is possible for instance in the above-described situation when the application program is copied from one terminal to another, the licence management program offers the user a chance to purchase a licence. The user may be offered a full licence (212) for using the program, a window preferably opening on the display of the terminal, the window specifying the fee of at least the full licence, the acceptance of which being subject to the user's acknowledgement by means of the user interface. If the user accepts the full licence, information about a new application program licence is added to the cash routine of the licence management program (214), the information preferably comprising a licence fee, an application identifier (Appl_ID) and optionally a distributor identifier (Distr_ID).

The licence management program may also preferably offer the user a chance to have a temporary, e.g. a 30-day, licence (216). In this case, a new window preferably opens on the display of the terminal, wherein at least the fee for the temporary licence is specified, the acceptance of which being subject to the user's acknowledgement by means of the user interface. If the user accepts the temporary licence, information on a new application program is added in the above-described manner to the cash routine of the licence management program. This allows the user to first test the program temporarily by paying a smaller fee before deciding to get a full licence for the program. Furthermore, the licence management program may include a setting according to which, always when the fee for the full licence or a still unpaid portion thereof exceeds the limit value set by the operator on the price of the single payment, such as a payment short message, the user is always offered a licence that is valid for the time being (e.g. 30 days) and will be renewed as many times as required in order for the total price of the licence to be compensated. When the user acknowledges the temporary licence as accepted, the licence management program starts a timer that determines the point in time when the licence is to be renewed the next time. If the user does not know the licence code of the application program or he does not want to accept a full or temporary licence, the application program is closed and its use is inhibited for the time being (218).

Accordingly, the cash routine of the licence management program collects information on application programs used in the terminal and accepted by the user to be charged. For each application program, the cash routine stores at least a licence fee, and application identifier (Appl_ID) and optionally the identifier of a distributor and/or a second terminal that delivered the application (Distr_ID, TE1_ID) (208). Hereby, information is preferably stored in the cash routine not only on the application itself and its price, but also on all the distribution chain via which the application program was delivered to the terminal. Next, the cash routine checks the total sum of the stored licence fee and if it exceeds or is equal to an operator-specifically defined limit value (220) of a single payment, such as a payment short message, the operator is transmitted a message (222) including the single payment charge, e.g. a short message at the price of 2 euros.

Each initiation (200) of the application program also initiates the licence management program from the start (202), whereby the licence management program checks the user rights of the application program in the above-described manner. In the above-described step, where the total sum of licence fees is compared with the operator-specifically specified single payment (220), the outcome may also be that the total sum is less than the specified single payment. In this case, the single payment charge is not sent to the operator; instead, the user may be offered the chance to load and register a new application program.

If the user does not order a new application, the licence management program still checks if unpaid licence fees, the sum of which is less than the specified single payment, remain in the cash routine. If no unpaid licence fees exist, the execution of the licence management program can be interrupted to wait for the next licence registration. If again unpaid licence fees remain in the cash routine, the licence management program initiates the timer for a predetermined time, e.g. for 14 days, whereby, if no new licence registration instances are performed during said time, the operator is sent a message (222) including a charge, e.g. a text message whose price is set to equal the remaining unpaid licence fee.

In this way the licence management program collects small payments from licence registrations until the total sum of the payments exceeds the specified single payment, after which payments are charged in the amount of the single payment by sending the operator a message, e.g. a short message, whose price equals that of the specified single payment and which includes information on applications (Appl_ID) associated with said single payment charge, portions of the licence fees of the applications, and optionally the identifier of a distributor and/or a second terminal that delivered the application (Distr_ID, TE1_ID). This information is used to divide the income composed of the licence fees between the application developer (SWD), the operator OP and an optional distributor D and second terminal TE1 that delivered the application in a proportion agreed upon by said parties in advance.

The accumulation of licence fees in the cash routine and the payment of the charges as specified single payments are illustrated in the following by means of the example shown in the diagram of FIG. 3. In this example, the magnitude of the operator-specific single payment is specified by means of a short message to be 2 [symbol] . At first (step 1), no application program is installed in the terminal, whereby no licence fees are accumulated in the cash routine. Next (step 2), the user loads an application program Appl1, whose price is 0.20 [symbol] , and which sum is accumulated in the cash routine. Then (step 3), the user loads a second application program Appl2, whose price is 0.80 [symbol] . By now, a total of 1.00 [symbol] of licence fees is accumulated in the cash routine. Next (step 4), the user loads a third application Appl3, whose price is 2.00 [symbol] , making the total sum of licence fees 3.00 [symbol] . Since the total sum of licence fees exceeds the specified single payment, a short message acknowledging one single payment (2 [symbol] ) is transmitted from the terminal to the operator by means of the licence management program (step 5), the short message including information on all three applications (Appl_ID:s) mentioned, their portions of the charge (Appl1 0.20 [symbol] , Appl2, 0.80 [symbol] and Appl3 1.00 [symbol] ), and any application distributors (Distr_ID) and/or terminals (TE1_ID) that delivered the applications.

Since the operator-specific single payment is specified as 2 [symbol] , 1 [symbol] remains unacknowledged in the cash routine for the third application program Appl3. Next (step 6), the user loads a fourth application program Appl4, whose price is 1 [symbol] , whereby the accumulated total sum of licence fees in the cash routine is 2 [symbol] , which thus corresponds to the operator-specific single payment. Accordingly, a short message (step 7) acknowledging one single payment (2 [symbol] ) is sent from the terminal to the operator by means of the licence management program in the above-described manner, the message including information on both applications (Appl3, Appl4), their charge portions (Appl3 1.00 [symbol] and Appl4 1.00 [symbol] ), and any distributors (Distr_ID) of the applications and/or terminals (TE1_ID) that delivered the applications. This single payment acknowledges all licence fees in the cash routine, zeroing the number of unacknowledged fees.

For specifying the transmission of short messages including a single payment, the licence management program comprises a function for determining the operator's telephone number, to which the short messages are sent. The licence management program may comprise several operator numbers, whereby for instance the application to be loaded may include information on the operator with which the application developer SWD has made a charge contract. This being so, the licence management program may include operator-specific cash routines, the licence fees accumulated in which are transmitted to an operator-specific number preferably as a short message. Furthermore, the licence management program includes a function for determining an operator-specific single payment used as the charge of the short message. The single payment may be the only alternative specified by the operator or the operator may offer several alternative magnitudes for the single payments. It is also feasible that the user of the licence management program is freely able to specify the size of the single payment. Typically, operator-specific single payments of short messages vary between 0.10 and 4.00 [symbol] .

In the above examples, the operation of the licence management program was described in situations where the user of the terminal loads a new application program into a terminal, the licence fees of which are specified in the above-described manner. However, the licence management program may equally well be applied to a situation where the user or the applications programs themselves tend to update programs or their contents. It may be necessary to load an update part into the application program or a plug-in that utilizes a new feature. The object of the loading may be any file, such as a text file containing the day's news. In this case, the application program can be set to request an acknowledgement of such a file being loaded into the terminal from the user by using some data transfer mode supported by the terminal. If the user accepts the loading and the loading succeeds perfectly, the user is charged for this preferably in the above-described manner.

In accordance with a preferred embodiment, the user of the terminal is also able to collect money in the cash routine, for instance by delivering application programs or other files to other terminals or by accepting the reception of advertisement messages in the terminal. These measures are registered in the cash routine as inverse payment instances that are reported to the operator in the next payment short message acknowledging licence fees and thus including information on not only the loaded applications and other files but also information on the refunds of inverse payment instances, their refund portions and the party paying the refund. The operator can use this information to bill the refunds from the parties concerned, such as advertisers, or subtract them from the accumulated licence fees if the user of the terminal has delivered application programs or other files to other terminals. To the user of the terminal, these refunds are preferably acknowledged as refunds in telephone bills.

The above-described examples are based on the premises that the terminal sends a payment short message to the operator when the charges accumulated in the cash routine reach the set limit for the single payment. In this case, a so-called MO (Mobile Originated) short message is involved. In accordance with a preferred embodiment of the invention, charging may also be performed by a so-called MT (Mobile Terminated) short message sent by the operator, wherein the accumulated charges are first indicated to the operator, for example using a regular short message, after which the operator acknowledges the charge by sending a payment short message having a predetermined price to the terminal. In this case, in accordance with a preferred embodiment of the invention, the operator may maintain a cash routine of the licence management program, whereby the terminal notifies the operator of new loaded files immediately after the licence is acknowledged, and the operator monitors the accumulation of the licence fees and sends the fees as specified single payments as illustrated in FIG. 3.

Although the acknowledgement of licence fees was described above preferably by means of payment short messages, a licence fee authorization payment to be sent to a trusted third party can also be implemented using any other messaging form. Particularly in a mobile communication environment, a chargeable WAP connection (Wireless Application Protocol) an be used or the charge message can be implemented as a call connection to a predetermined chargeable telephone number. In this case, the call connection can be established either as a data call or as a normal voice call, whereby DTMF (Dual Tone Multi Frequency) command strings can be used to specify the charging information.

FIG. 4 illustrates the structure of a mobile station MS according to a preferred embodiment of the invention. The MS comprises a transceiver Tx/Rx that attends to communication, e.g. the transmission and reception of payment short messages, with a base station BTS via an antenna. File reception in the terminal may also take place via said transceiver if a mobile communication protocol, such as GPRS or HSCSD data transfer, is used for file transfer. The mobile station MS may also preferably comprise means for file transfer via an infrared link or a short-range radio link, such as a Bluetooth connection. The user interface means UI (User Interface) typically comprise a display, a keyboard, a microphone and a loudspeaker. The MS also comprises a subscriber identity module SIM, for storing e.g. short messages, operator-specific data or user-specific settings. Computer program code that a central processing unit CPU executes can be stored in a memory MEM comprised by the mobile station MS.

The licence management functionality of the invention is most preferably implemented as a program code stored in the memory MEM and comprising a program code for requesting acknowledgement of a licence specified for a file from the user of the terminal, a program code for storing a predetermined single payment limit value for effecting a licence charge, a program code for receiving an acknowledgement of the file licence from the user of the terminal, a program code for performing file-specific storage, the storage comprising at least the price of the file, the identifier of the file and the identifier of at least one party to the distribution path of the file, a program code for summing up the prices of all loaded files, and a program code for the transmission of a message authorizing a charge amounting to the single payment to the third party attending to the charging, the message comprising information on the identifiers of the files to be charged in said single payment, on the identifiers of at least one party to the file distribution path, and the portion of each file in said single payment, the message being arranged to be transmitted in response to the summed-up price of all loaded files exceeding or being equal to said predetermined limit value of the single payment. The above functionalities can be most preferably implemented as software by means of existing processors and memories, but hardware solutions can also be used.

It is evident to a person skilled in the art that with technological advances the idea of the invention can be implemented in a variety of ways. Thus, the invention and its embodiments are not restricted to the above-described examples but may vary within the scope of the claims.

1. A computer-based method of confirming the user rights of a file to be loaded into a terminal, the method comprising:
loading at least one file with non-confirmed user rights into the terminal;
in response to starting execution of said file, initiating a user rights control application in said terminal;
determining, in the user rights control application, licence terms of said file as precondition for using said file in said terminal, said licence terms being delivered in association with said file and including at least duration and price of the licence;
displaying said licence terms for a user of the terminal to be accepted;
in response to receiving an acknowledgement from the user of the terminal of the licence terms of the file, storing file-specifically in said user rights control application at least the price parameter of the file, the identifier of the file and the identifier of at least one party to the distribution path of the file; and
approving in said user rights control application, with a processor in the terminal, said file to be executed in the terminal.

2. The method as claimed in claim 1, further comprising:
a predetermined single payment limit value being arranged to be stored in the terminal for effecting a licence charge, the method further comprising:
summing up the price parameters of all loaded files in said user rights control application; and
in response to the summed-up price of all loaded files exceeding or being equal to said predetermined single payment limit value, transmitting a message authorizing a charge amounting to the single payment to a third party responsible for the charge, the message comprising information on the identifiers of the files to be charged in said single payment, the identifiers of at least one party to the distribution path of the files, and the portion of the price parameter of each file in said single payment.

3. The method as claimed in claim 2, further comprising:
in response to a file being loaded into the terminal from a second terminal, adding the identifier of said second terminal to said message authorizing the charge and transmitted to the third party.

4. The method as claimed in claim 2, further comprising:
in response to measures authorizing a refund, such as the delivery of application programs or other files to other terminals or the reception of advertisement messages, being performed in the terminal, adding the identification data on said measures authorizing the refund to said message authorizing the charge and transmitted to the third party.

5. The method as claimed in claim 2, wherein said terminal is a terminal in a mobile network and said third party responsible for the charge is a mobile operator, the method further comprising:
transmitting said message authorizing a charge amounting to the single payment as a payment short message.

6. The method as claimed in claim 5, further comprising:
transmitting said payment short message from the terminal to the operator.

7. The method as claimed in claim 5, further comprising:
transmitting said payment short message from the operator to the terminal in response to charge information received from the terminal.

8. The method as claimed in claim 2, wherein said terminal is a terminal in a mobile network and said third party responsible for the charge is a mobile operator, the method further comprising:
delivering said message authorizing a charge amounting to the single payment by one of the following manners: a chargeable WAP link, a chargeable data call, a chargeable voice call utilizing DTMF command strings.

9. The method as claimed in claim 1, further comprising:
offering a temporary licence for using the loaded file to the user of the terminal for acknowledgement.

10. The method as claimed in claim 9, further comprising:
initiating a timer defining the validity period of the temporary licence in response to an acknowledgement of the temporary licence received from the user; and
offering a new temporary licence to the user of the terminal for acknowledgement once the timer defining the validity period of the previous temporary licence has expired.

11. A computer-readable memory encoded with program code for confirming the user rights of at least one file with non-confirmed user rights loaded into a terminal, wherein the program code is provided for:
determining licence terms of said file as precondition for using said file in said terminal, said licence terms being delivered to the terminal in association with said file and including at least duration and price of the licence;
displaying said licence terms for a user of the terminal to be accepted;
in response to receiving an acknowledgement from the user of the terminal of the licence terms of the file, storing file-specifically in said user rights control application at least the price parameter of the file, the identifier of the file and the identifier of at least one party to the distribution path of the file; and
approving in said user rights control application said file to be executed in the terminal.

12. The computer readable memory as claimed in claim 11, wherein the program code further provides for:
storing a predetermined single payment limit value in the terminal for effecting a licence charge;
summing up the price parameters of all loaded files in said user rights control application; and
transmitting a message authorizing a charge amounting to the single payment to a third party responsible for the charge, the message comprising information on the identifiers of the files to be charged in said single payment, the identifiers of at least one party to the distribution. path of the files, and the portion of the price parameter of each file in said single payment, the message being arranged to be transmitted in response to the summed-up price parameters of all loaded files exceeding or being equal to said predetermined single payment limit value.

13. A terminal in a telecommunication network, wherein the terminal includes a computer processor, the terminal being arranged to:
load at least one file with non-confirmed user rights into the terminal, initiate a user rights control application in said terminal, if execution of said file is started;
determine, by means of the user rights control application, licence terms of said file as precondition for using said file in said terminal, said licence terms being delivered in association with said file and including at least duration and price of the licence;
display said licence terms for a user of the terminal to be accepted;
receive an acknowledgement from the user of the terminal of the licence terms of the file;
store file-specifically in said user rights control application at least the price parameter of the file, the identifier of the file and the identifier of at least one party to the distribution path of the file; and
approve said file to be executed in the terminal.

14. The terminal as claimed in claim 13, wherein a predetermined single payment limit value is arranged to be stored in the terminal for effecting a licence charge, the terminal being further arranged to:
sum up the price parameters of all loaded files in said user rights control application; and
in response to the summed-up price of all loaded files exceeding or being equal to said predetermined single payment limit value, transmit a message authorizing a charge amounting to the single payment to a third party responsible for the charge, the message comprising information on the identifiers of the files to be charged in said single payment, the identifiers of at least one party to the distribution path of the files, and the portion of the price parameter of each file in said single payment.
